(19) United States
(12) Patent Application Publication
(10) Pub. No.: US 2002/0134298 A1
(43) Pub. Date: Sep. 26, 2002

(54) CLASSIFICATION FILE FOLDER MARKER TABS

(76) Inventor: DAVID C. SCHWARTZ, SOUTHBORO, MA (US)

Correspondence Address: DAVID C SCHWARTZ, P O BOX 109, SOUTHBORO, MA, 01772

(21) Appl. No.: 09/450,619

(22) Filed: Nov. 30, 1999

Related U.S. Application Data
(60) Provisional application No. 60/112,755, filed on Dec. 17, 1998.

(51) Int. Cl. B42F 21/00

(52) U.S. Cl. 116/234; 283/37

(57) ABSTRACT

This invention relates to the separating of papers in a file folder and to a simple, minimalist formation of a multi separator leaf which can be easily attached to a file folder or integrally formed with a file folder and whose multiple sections can be split apart and used to provide individual dividers for separate batches of paper. The invention provides for a single leaf comprising a leaf body and a leaf hinge portion, where the leaf body is separable into a plurality of marker tab sections, while remaining hingedly attached to the leaf hinge portion, and where the leaf hinge portion can be attached to or is integrally attached at the spine of a file folder so as to become a part thereof, for providing a selective means of separating one or more sheets of paper between successive marker tab sections.

This application is a formal utility patent filing on provisional patent application “Classification Marker Tabs”, No. 60/112,755, filed Dec. 17, 1998.

### BACKGROUND OF THE INVENTION

This invention relates to the separating of papers in a file folder and to a simple, minimalist formation of a multi separator leaf which can be easily attached to a file folder or integrally formed with a file folder and whose multiple sections can be split apart and used to provide individual dividers for separate batches of paper. The invention provides for a single leaf comprising a leaf body and a leaf hinge portion, where the leaf body is separable into a plurality of marker tab sections, while remaining hingedly attached to the leaf hinge portion, and where the leaf hinge portion can be attached to or is integrally attached at the spine of a file folder so as to become a part thereof, for providing a selective means of separating one or more sheets of paper between successive marker tab sections.

The invention relates to a way of providing the lightest weight, thinnest multi-separator system for a file folder. Traditionally papers are put between the front and rear covers of a folder in a pile or batch. Recently, multi-pocket files having multiple segments have become popular. where the file is segmented into pockets. These files are essentially closed files having at least two closed sides. They do not operate as a folder. Sectioned classification files have existed where each section is a full panel and multiple full panels are used to separate the file. The panels may be integrally formed with the file or may be attached as an accessory. In any case, the partitioning of the file into multiple sections requires a full sized panel for each partion. The partions may be dropped in, i.e. Unattached, or may be attached at the hinge of the spine of the file folder. So classification file folders have been available with full card separators as classification tab markers.

This invention relates to classification tab markers formed as a portion of a full card divider. Full card dividers add cost and weight and bulk to a file folder. The advantage of this separable classification market tab card is that one card can provide multiple indexes by separating each as needed. The separable classification marker tab card can be integrally glued into a file folder, or can be provided as an accessory that is added in. The adhesive can be permanent or removable. The separator perfs can extend to the hinged attachment flap or can go straight through the flap used to attach the marker card to the folder.

By hinging each separator tab together, the separators retain their positon with respect to each other, adding stability to the file when full and allowing for the easy turning of a batch of separated papers without the dislodging of each marker tab section.

The invention therefore relates to the provision of a paperboard separator page having multiple sections, hingedly attached one to the next at a hinged end, and attachable as a leaf to a file folder at a file folder spine hinge. The invention relates to the formation of such a multi-section leaf with perforations to permit user separation of each section. The invention relates to the formation of such a multi-section leaf where each separable section is tinted or printed in a different color. The invention relates to the formation of such a multi-section leaf with an activatable adhesive strip on a hinged flap, where the adhesive may be activated by peeling a strip of release coated paper, for example, from the adhesive to expose the adhesive. The invention relates to the formation of such a multi-section leaf in plastic.

### SUMMARY OF THE INVENTION

The object of the present invention is to provide a light weight, cost effective classfication index marker card where the index strips can be readily separated as needed and where the card can be added to any file as needed. Further, the object is to provide a tab strip which can be separated from the marker leaf card at (either) the hinge so that the tab section can be completely removed from the marker leaf for attachment to the batch of papers it was used to separate. (or) The object of the invention is to provide for a set of marker tabs which can be separated in such a way as to be permanently retained at the hinge portion providing for a set of separator strips whose relative position one to the other is fixed. (so as) The object is to provide that in either case for the multi-section marker leaf to be attached to the hinged spine of a host file folder. And in the case where the tabs are removable from the marker leaf card, they may be easily attached by some means, as with staple, clip, or adhesive to the batch of papers it is classifying. It is the object of the invention to provide for a very stable by easily separable perf separating each marker tab of the multi-marker tab leaf, where the perf is formed with at least two large cuts and a small land area between the cuts that can be easily “broken” apart by the user to form a free swinging marker tab section. It is the object of the invention to provide for a hinged flap with adhesive, where the adhesive is covered by a release coated strip which can be removed to expose and activate the ahesive for attaching the assembly to a host file folder.

### BRIEF DESCRIPTION OF THE DRAWINGS

The above and other objects and advantages of the invention will be apparent from consideration of the following detailed description, taken to conjunction with the accompanying drawings, in which like reference characters refer to like parts throughout.

FIG. 1 Shows a perspective of a host file folder and a classification marker leaf with tabbed sections.

FIG. 2 Shows a classification marker leaf with tabbed sections, having an aggressive perforation separating each section

FIG. 3 Shows a 6th cut tab leaf with a peelable adhesive strip on its hinged flap.

FIG. 4 Shows a third cut tabl leaf with exposed adhesive

FIG. 4A Shows a preferred embodiment of a perforation for easily separating each tabbed section. The perf stop at the hinged flap section.

FIG. 5 Shows a third cut tabbed leaf with expansion area and marked peel strip. The perfs extend through the hinged flap section.

FIG. 6 Shows a poly file folder and poly classification separator where the classification leaf is integrally formed with the host file folder.

FIG. 7 Shows a perspective drawing of a “loaded” file showing how the tabbed separators segment the papers contained therein.

### DETAILED DESCRIPTION OF THE INVENTION

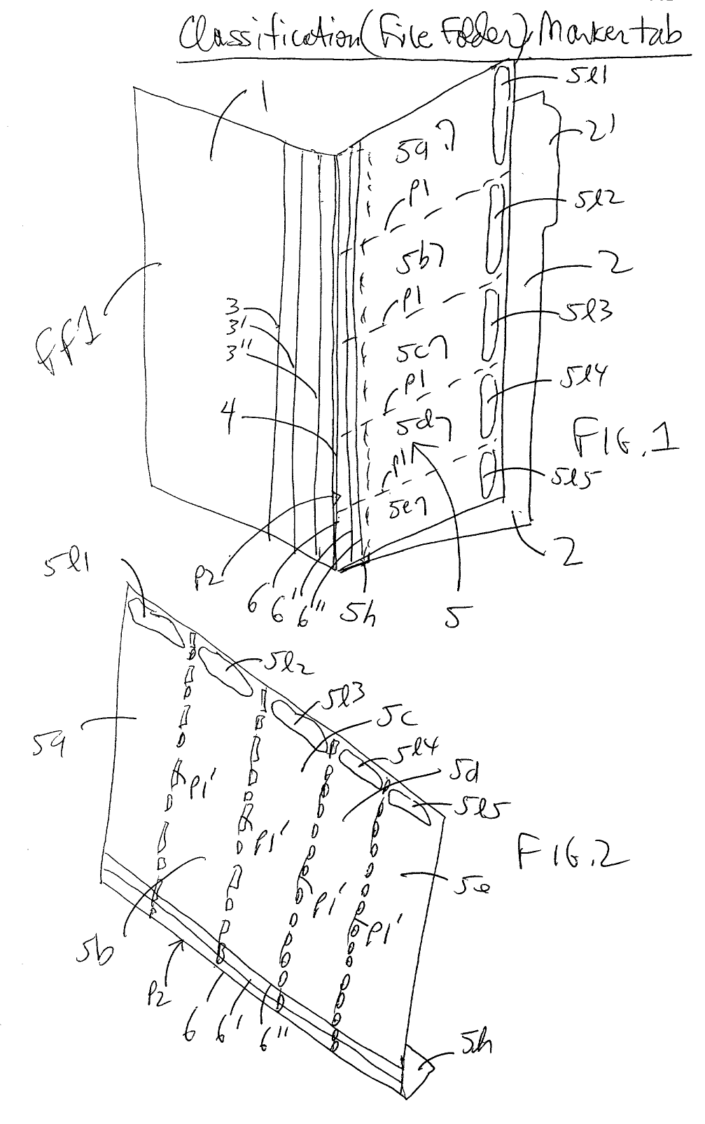

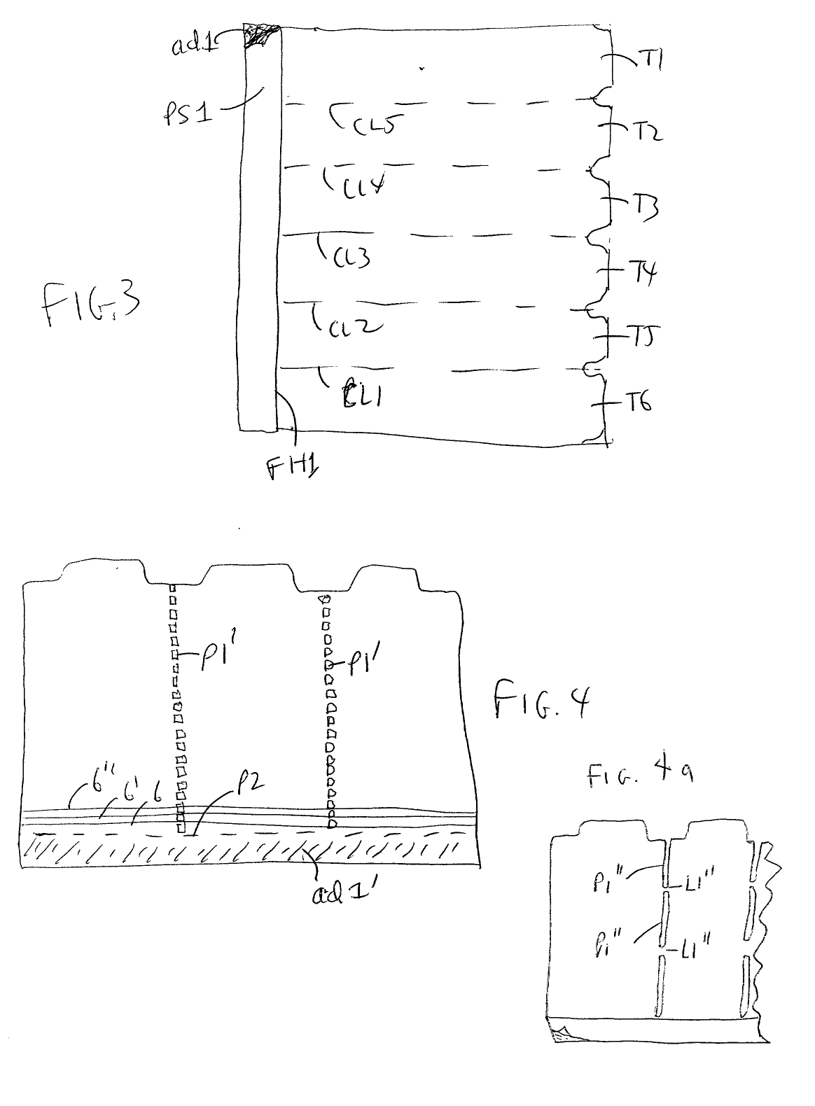

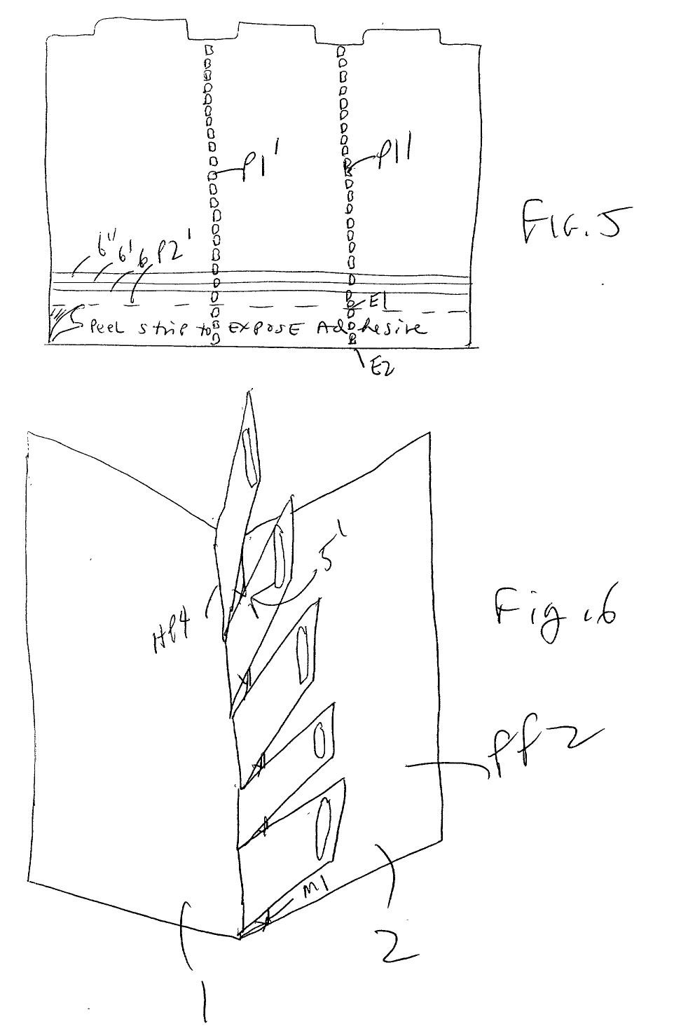

A preferred embodiment is shown in FIG. 1 where a file folder, FF1, Comprising front, 1, and back cover, 2, has a marker card 5 attached permanently thereto, as an integral combination. Each perf, P1, can be separated to let each tab marker portion, 5a, swing separately about hinge p2. The flap, 5h, is the means for attaching the card 5, to the file folder ff1. The hinge p2 is a fold perf, sufficient to weaken the fibre of the card and permit easy folding. Of course, for a impermanently attached marker tab set, the hinge p2 can be formed as a fold hinge without any perforation, such as by striking with a rule edge to preform the fold crease. Perf p1 is a tear perf and is easily separated. The preferred way to make this tear perf for a paperboard card separator Would naturally be to make a number of substantially large slit cuts connected by small “landed” areas as the means for separating each marker tab, one from the other. In this way, the card will retain some integral stability when first Inserted, and each marker tab will easily separate one from the next, leaving clean edges along the tab length. The proposed embodiment is formed in paperboard.

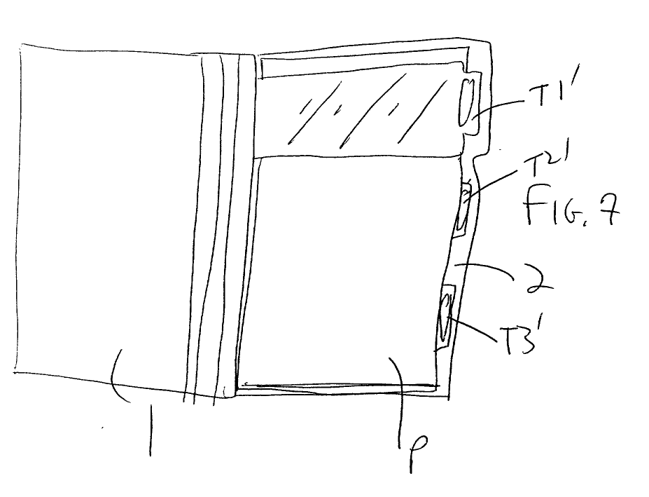

FIG. 6 shows an alternative material, plastic, in which a preseparted classification tab marker is “melted” by attachment means such as RF or heat at the hinge flap and spine. The material used can be poly plastic, in which case the means for attachment could still be an adhesive strip, peelable in the case of an accessory formulation. For directly attached embodiments where the file folder and the marker tab are the poly plastic, adhesive can be used or one of the traditional methods for sealing poly plastic such as RF or heat blade melting can be employed.

Any number of tab portions can be provided. The tab extent has an optional expansion portion 6, 6′, 6″ to permit capacity filling. The tabs will shorten slightly but if the original height of the tab is substantially to the top edge of the back of the file folder, the index label areas will remain visible even when the file is fully loaded.

A preferred embodiment as an accessory has a peal strip, ps1, which once removed exposes either a repositionable adhesive, ad1, or a permanent adehsive, ad1′.

The hinge can be have printed indicia on it as can be the tab separator markers.

The tear perf p1′ can extend through the attachment hinge or stop short of the attachment hinge. If it extends through, when used with a repositional adhesive, the tab markers can be separated and attached to a host leaf, like a repositional, note.

If paper board is used, a reasonably weighted paper is preferred to provide strength on lifting batches of papers when the separator sections are filled, and to differentialte it from plain paper. If plastic is used, the plastic can be preseparated or can be perfed agressively or perfed using the large slits sand small land segments, for user separation.

One skilled in the art will appreciate that the present invention wan be practiced by other than the embodiments described, which are presented for the purpose of illustration and not of limitation, and the present invention is limited only by the claims which follow: What is claimed is:

1. A combination of a classification tab marker having separable tab portions in combination with a file folder, the hinged flap of the classification tab marker being substantially colinear with the spine of the file folder.

2. A classification tab marker having separable portions and a hinged flap for attachment to a host surface, said hinged flap having adehsive there on and a peel strip for temporarily coveing said adhesive.

3. A plastic classification tab marker having at least two separable portions and a hinged flap for attaching to a host plastic surface.
